(19) United States
(12) Patent Application Publication
(10) Pub. No.: US 2016/0089306 A1
(43) Pub. Date: Mar. 31, 2016

(54) STACKABLE BABY BOTTLE ASSEMBLY WITH NESTABLE CAP AND METHOD THEREFOR

(71) Applicant: Eric CHEE, Alhambra, CA (US)

(72) Inventor: Eric CHEE, Alhambra, CA (US)

(21) Appl. No.: 14/500,540

(22) Filed: Sep. 29, 2014

(51) Int. Cl. A61J 9/00

(52) U.S. Cl. CPC A61J 9/00

(57) ABSTRACT

A stackable baby bottle assembly with a nestable cap comprises a bottle base, a ring, a nipple, a cap, and, optionally, a sieve. The bottle base includes a plurality of edge members. A plurality of bottle bases may be stacked for storage. When a plurality of bottle bases are stacked, the edge members form space between the bottle bases, thereby permitting air to flow between the bottle bases. The bottle base and cap may include nesting regions, such that the cap may be inverted and snapped onto place onto the bottom of the bottle base, which may be convenient during feeding. A plurality of caps may be stacked for storage.

### FIELD OF THE INVENTION

This invention relates generally to feeding apparatuses for young children such as babies and toddlers and, more particularly, to a stackable baby bottle assembly having a nestable cap.

### BACKGROUND OF THE INVENTION

Feeding apparatuses such as baby bottles are frequently used by parents and other caregivers to feed babies and toddlers. There are different varieties of baby bottles generally known in the art. Households having young children such as babies and toddlers often have a plethora of feeding apparatuses, including baby bottles, and other types of baby gear within the household. Such items can take up substantial amounts of space and may present challenges in keeping them neat and organized. In order to meet such organizational challenges, feeding apparatuses have been developed in the art that may be stacked upon each other. In this way, when stored, the feeding apparatuses may be neatly organized.

However, there are limitations with such prior art feeding apparatuses. In this regard, when various components of a feeding apparatus—such as baby bottles—are stacked, there is typically very limited to no space between the baby bottles, thereby restricting or even prohibiting airflow. This can be problematic. For example, after washing the baby bottles after use, a user may desire to allow the baby bottles to air dry. If the baby bottles are stacked before they are completely dry, it can be very difficult for the baby bottles to completely air dry. Furthermore, even if the baby bottles are first dried with a towel, water droplets may remain in the bottles. If the baby bottles are stacked with water droplets remaining therein, it can still be very difficult for the baby bottles to completely dry. It is commonly understood that storing feeding apparatuses, as well as dishes and other eating utensils in general, while wet should be avoided. This is because these wet items can easily become contaminated with bacteria, since a moist, warm environment can present optimal conditions for bacterial growth. It is potentially hazardous to a child's health to feed a child with feeding apparatuses that have become contaminated with bacteria. If such items become contaminated with bacteria, they must be rewashed prior to use, which can be cumbersome and time consuming, particularly for busy caregivers.

A need therefore exists for a stackable baby bottle assembly that permits air to flow into the baby bottles when stacked.

The present invention satisfies these needs and provides other, related advantages.

The features, functions, and advantages may be achieved independently in various embodiments of the disclosure or may be combined in yet other embodiments.

### SUMMARY OF THE INVENTION

In accordance with an embodiment of the present invention, a baby bottle assembly is disclosed. A baby bottle assembly has a bottle base having a plurality of edge members formed in an interior perimeter of the bottle base. The edge members form spaces when a plurality of bottle bases are stacked together. A ring is coupled to the bottle base. A nipple is adapted to be placed onto the bottle base. A cap is adapted to be snapped into place onto the ring.

In accordance with an embodiment of the present invention, a baby bottle assembly is disclosed. The baby bottle assembly comprises, in combination: a bottle base having a closed bottom, a side wall, an open top, a plurality of edge members formed in an interior perimeter of the bottle base, and an external threaded region positioned proximate the top of the bottle base; a ring having an outer wall, a threaded inner wall, a lip, and a shoulder; a nipple having a lower edge, a generally rounded base portion, and a tip; a cap having an open bottom, a side wall, a closed top, and a capsule positioned in an interior region of the closed top; wherein the nipple is adapted to be placed onto the bottle base; wherein the threaded inner wall of the ring is adapted to be threadably coupled to the external threaded region of the bottle base and wherein the lip of the ring is adapted to secure the lower edge of the nipple onto the bottle base when the ring is coupled to the bottle base; wherein the cap is adapted to be snapped into place onto the shoulder of the ring; and wherein the capsule is adapted to receive the tip of the nipple when the cap is in place on the shoulder of the ring.

In accordance with another embodiment of the present invention, a baby bottle assembly is disclosed. The baby bottle assembly comprises, in combination: a bottle base having a closed bottom, a side wall, an open top, a plurality of edge members formed in an interior perimeter of the bottle base, and an external threaded region positioned proximate the top of the bottle base; a sieve comprising a circular-shaped disk having a plurality of openings; a ring having an outer wall, a threaded inner wall, a lip, and a shoulder; a nipple having a lower edge, a generally rounded base portion, and a tip; a cap comprising an open bottom, a side wall, a closed top, and a capsule positioned in an interior region of the top; wherein the sieve is adapted to be removably positioned between the bottle base and the ring; wherein the nipple is adapted to be placed onto the sieve; wherein the threaded inner wall of the ring is adapted to be threadably coupled to the external threaded region of the bottle base and wherein the lip of the ring is adapted to secure the lower edge of the nipple onto the sieve when the ring is coupled to the bottle base; wherein the cap is adapted to be snapped into place onto the shoulder of the ring; and wherein the capsule is adapted to receive the tip of the nipple when the cap is in place on the shoulder of the ring.

### BRIEF DESCRIPTION OF THE DRAWINGS

Embodiments of the disclosure will become more fully understood from the detailed description and the accompanying drawings, wherein:

FIG. 1 is an exploded perspective view of a baby bottle assembly, consistent with an embodiment of the present invention.

FIG. 2 is a front view of a baby bottle assembly, consistent with an embodiment of the present invention.

FIG. 3 is a front view of a baby bottle assembly, consistent with an embodiment of the present invention.

FIG. 4 is a top perspective view of a bottle base to be utilized with the baby bottle assembly of the present invention.

FIG. 5 is a front perspective view of the bottle base of FIG. 4, with a sieve component to be utilized with the baby bottle assembly in position thereon, consistent with an embodiment of the present invention.

FIG. 6 is a perspective view of a ring component to be utilized with the baby bottle assembly of the present invention.

FIG. 7 is a perspective view of a bottle base to be utilized with the baby bottle assembly of the present invention.

FIG. 8 is a perspective view of a bottle base to be utilized with a baby bottle assembly of the present invention.

FIG. 9 is another front view of the baby bottle assembly of FIG. 2.

FIG. 10 is a back view of the baby bottle assembly of FIG. 9, with a bottle base thereof nested within a cap thereof, consistent with an embodiment of the present invention.

FIG. 11 is a front view of a baby bottle assembly, consistent with an embodiment of the present invention.

FIG. 12 is a back view of the baby bottle assembly of FIG. 11, with a bottle base thereof nested within a cap thereof, consistent with an embodiment of the present invention.

FIG. 13 is a front view of a plurality of caps to be utilized with the present invention, positioned in a stacked arrangement, consistent with an embodiment of the present invention.

FIG. 14 is another front view of the baby bottle assembly of FIG. 2, with a cap thereof removed from the top of the assembly.

FIG. 15 is a front view of the baby bottle assembly of FIG. 14, with a bottle base thereof nested within a cap thereof, consistent with an embodiment of the present invention.

FIG. 16 is back view of a plurality of bottle bases to be utilized with the present invention, positioned in a stacked arrangement, consistent with an embodiment of the present invention.

FIG. 17 is a back view of a plurality of bottle bases to be utilized with the present invention, positioned in a stacked arrangement, consistent with an embodiment of the present invention.

FIG. 18 is a perspective view of the plurality of bottle bases of FIG. 16.

### DETAILED DESCRIPTION

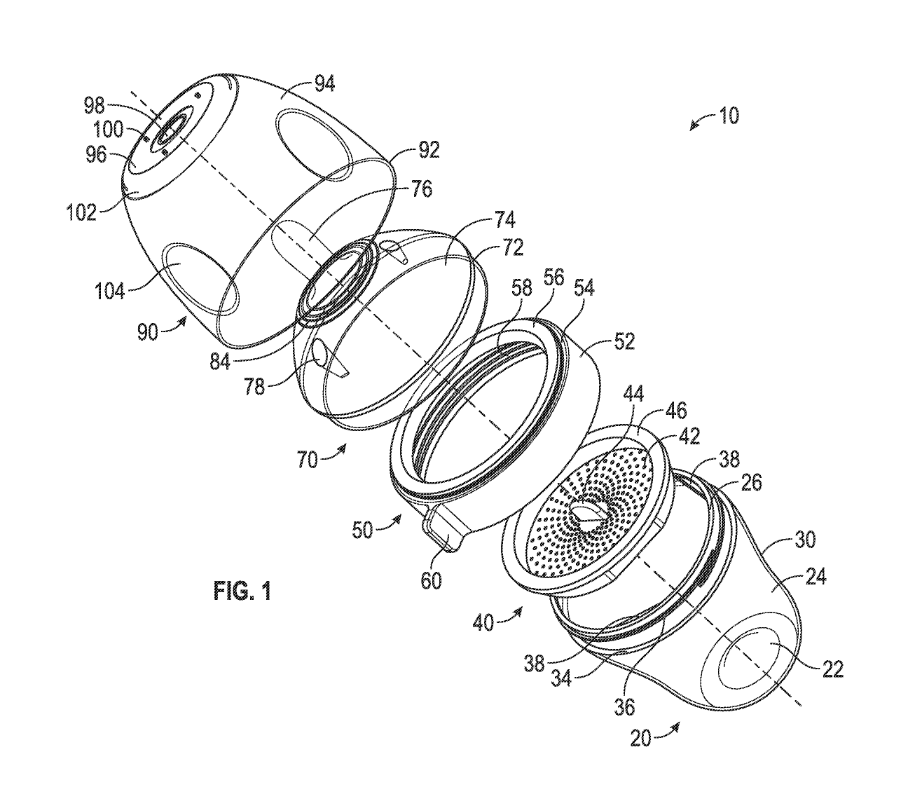

Referring first to FIG. 1, an embodiment of a stackable baby bottle assembly 10, consistent with an embodiment of the present invention is shown. The baby bottle assembly 10 may be comprised of the following principal components: a bottle base 20, a sieve 40, a ring 50, a nipple 70, and a cap 90.

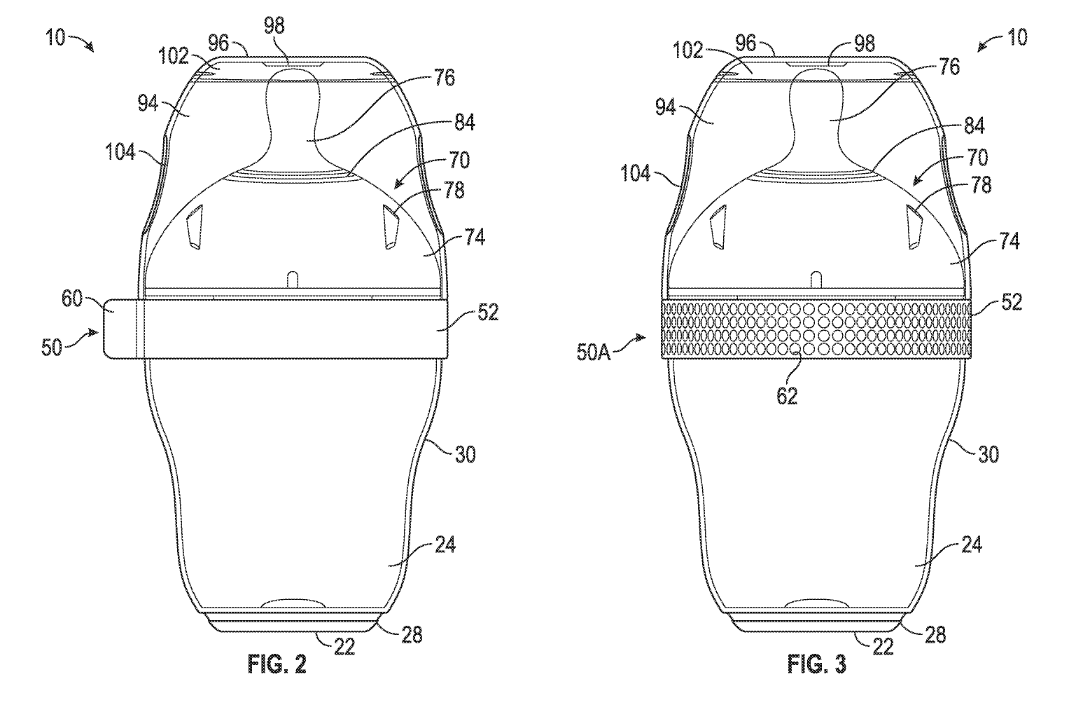

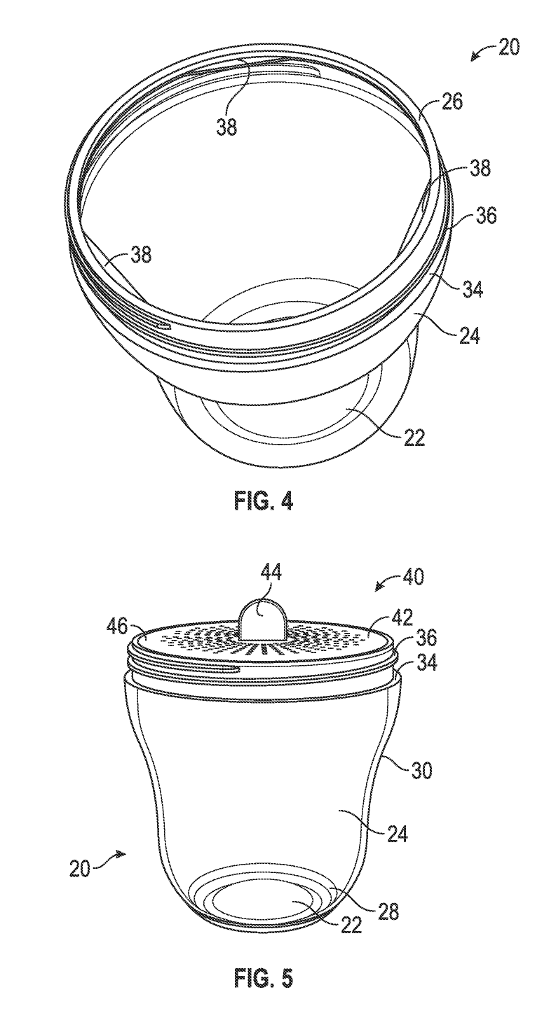

Referring now to FIGS. 1 and 4, particular attention is drawn to the bottle base 20. The bottle base 20 is generally cup-shaped, with a closed bottom 22, a side wall 24 defining a perimeter of the bottle base 20, and an open top 26. The bottom 22 of the bottle base 20 may be dome-shaped, as seen, for example, in FIGS. 1 and 5. The bottle base 20 may further include a nesting region 28 positioned proximate the bottom 22 of the bottle base 20, as seen, for example, in FIGS. 2-3, to permit the bottle base 20 to be nested within the cap 90, as further described herein. The side wall 24 of the bottle base 20 may be generally rounded in shape and may include a concave groove region 30. In this way, the bottle base 20 may be easy to grasp and hold for a caregiver or a young child, such as a baby or toddler. The side wall 24 may include gradation markings on an exterior thereof. The gradation markings may include liquid measurement markings in English or metric units, such as ounces or milliliters. In one embodiment, the gradation markings may include liquid measurement markings up to 5 ounces and up to 150 milliliters. However, it should be understood by those skilled in the art that liquid measurement markings outside of these ranges may be provided, consistent with the spirit and scope of the present invention.

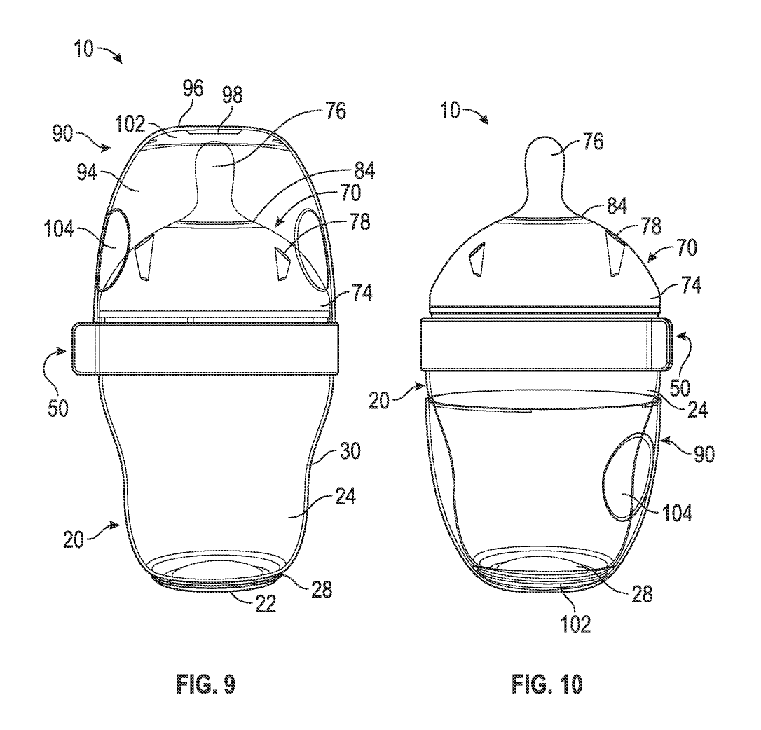

The sidewall 24 may vary in thickness from bottom 22 to top 26 of the bottle base 20, with the side wall 24 having a generally greater thickness toward the top 26 of the bottle base 20 as compared to the bottom 22 of the bottle base 20. This provides for a fluid shape of the overall baby bottle assembly 10, particularly when the ring 50 is coupled to the bottle base 20, as further described herein. When coupled to the bottle base 20, the ring 50 may be flush with the bottle base 20; however, this is not required. As shown in FIGS. 1-5, 8, and 9, for example, the bottle base 20 may be generally tapered from top 26 to bottom 22, such that a circumference of the top 26 of the bottle base 20 is wider than a circumference of the bottom 22 of the bottle base 20. With this general tapering, the bottle base 20 is designed to be able to fit in a standard cup holder.

The bottle base 20 further includes a shoulder 34 and an external threaded region 36 proximate the top 26 of the bottle base 20. The external threaded region 36 enables the bottle base 20 to be removably coupled to the ring 50, as further described herein.

The top 26 of the bottle base 20 includes a plurality of edge members 38 extending from an interior perimeter of the bottle base 20, as seen, for example, in FIGS. 1 and 4. In this embodiment, three edge members 38 are employed. However, it should be understood by those skilled in the art that more than three edge members 38 or less than three edge members 38 may be employed, consistent with the spirit and scope of the present invention. The edge members 38 are straight, in contrast to the curvature of the perimeter of the bottle base 20. The edge members 38 permit a plurality of bottle bases 20 to be stacked for storage while permitting airflow therethrough, as further described herein. The plurality of edge members 38 may be positioned slightly below the top 26 of the bottle base 20. This may allow a top surface 46 of the sieve 40 to sits flush with the top 26 of the bottle base 20.

In one embodiment, the bottle base 20 may be transparent and may be comprised of a clear finish.

With respect to the dimensions of the bottle base 20, in one embodiment, the bottle base 20 may be dimensioned to contain approximately 5 ounces or 150 milliliters of fluid. In this embodiment, the baby bottle assembly 10 may have a total height of 143.3 millimeters and a diameter at its widest part of 77.6 millimeters. However, the bottle base 20 may be dimensioned to contain more or less fluid outside of these dimensions, and the baby bottle assembly 10 may have varying heights and diameters, as desired, consistent with the spirit and scope of the invention.

Referring now to FIGS. 1 and 5, particular attention is drawn to the sieve 40. The sieve 40 may comprise a generally circular-shaped disk having a plurality of openings 42 and a handle 44 positioned on a central region of the disk. The sieve 40 is adapted to fit between the bottle base 20 and ring 50 when the baby bottle assembly 10 is assembled. When in position, the sieve 40 rests on top of the edge members 38 of the bottle base 20, such that a top surface 46 of the sieve 40 sits flush with the top 26 of the bottle base 20. With its plurality of openings 42, which are sized to allow fluid to pass therethrough, the sieve 40 helps to prevent the passage of formula clumps into the nipple 70 when the baby bottle assembly 10 is in use. This may help to prevent buildup of formula clumps in the nipple 70, thereby preventing a tip 76 of the nipple 70 from becoming clogged. The sieve 40 further helps to remove foam and/or air from formula and/or milk when the baby bottle assembly 10 is in use, thereby helping to prevent a child from ingesting excess air during bottle feeding and, in turn, helping to prevent discomfort that a child may experience during and after bottle feeding due to a buildup of excess gas, as well as helping to prevent colic. The handle 44 may be gripped by a user, permitting easy removal of the sieve 40 from the bottle base 20. While in this embodiment the sieve 40 is a component of the baby bottle assembly 10, use of the sieve 40 is optional. It may be desired to use the baby bottle assembly 10 without the sieve 40. Such use would be consistent with the spirit and scope of the present invention.

In one embodiment, the sieve 40 may be transparent and may be comprised of a clear finish. It may also be desired for the sieve 40 to be opaque and to be comprised of various different color finishes, which would be consistent with the spirit and scope of the present invention.

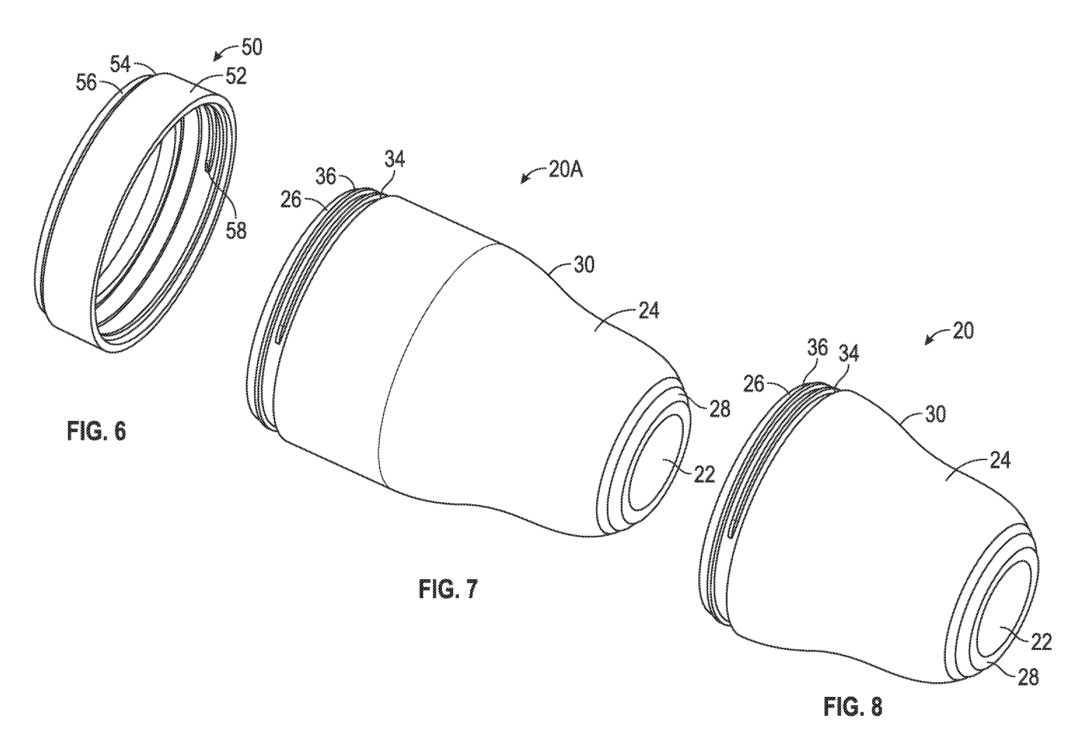

Referring now to FIGS. 1-2 and 6, particular attention is drawn to the ring 50. The ring 50 comprises an outer wall 52, a shoulder 54, a lip 56, and a threaded inner wall 58. The outer wall 52 may include a tab 60, as shown, for example, in FIGS. 1-2. Branding may be included on the tab 60, if desired, to feature a particular brand name that may be associated with the baby bottle assembly 10. Such branding may be imprinted on the tab in a recessed manner, in a raised manner, or in a flat manner, as desired. As can be seen in FIG. 1, a circumference of the outer wall 52 is greater than a circumference of the lip 56. In this way, the cap 90 of the baby bottle assembly 10 may be snapped into place on top of the ring 50, with a bottom of the cap 90 resting on the shoulder 54 of the ring 50. Further, the lip 56 is adapted to hold the nipple 70 in place when the baby bottle assembly 10 is fully assembled, as further described herein. The ring 50, at its threaded inner wall 58, is adapted to be removably coupled to the bottle base 20, at threaded region 36 of the bottle base 20. The tab 60 may assist with coupling and uncoupling the ring 50 to the bottle base 20, by providing a surface to which a user can apply force with a thumb or finger in order to screw or unscrew the ring 50 from the bottle base 20. In this embodiment, as shown in FIGS. 1 and 2, the outer wall 52 may be comprised of a smooth surface. The smooth surface helps to facilitate easy cleaning of the ring 50. In one embodiment, the ring 50 may be opaque and may be comprised of various different color finishes, as desired. It may also be desired for the ring 50 to be transparent and comprised of a clear finish, which would be consistent with the spirit and scope of the present invention.

Referring now to FIG. 3, another embodiment of the ring 50, hereinafter 50A, consistent with an embodiment of the present invention is shown. The ring 50A is similar to the ring 50, except that the outer wall 52 is comprised of a dimpled surface having a plurality of dimples 62, and a tab is not present. In this embodiment, the dimpled surface provides a gripping surface for the user to assist with coupling and uncoupling the ring 50A to the bottle base 20.

Referring now to FIGS. 1-3 and 9-10, particular attention is drawn to the nipple 70. The nipple 70 comprises a lower edge 72, as may be seen in FIG. 1, a generally rounded shape base portion 74, and a tip 76. The lower edge 72 is adapted to be seated on top of the sieve 40, when the sieve 40 is in use, or on top of the edge members 38 of the bottle base 20, if the sieve 40 is not in use, when the baby bottle assembly 10 is fully assembled. When the ring 50 is screwed onto the bottle base 20, the lip 56 of the ring catches lower edge 72 of the nipple 70, holding the nipple 70 in place when the baby bottle assembly 10 is fully assembled. The base portion 74 includes a plurality of ventilation channels 78. In this embodiment, two ventilation channels 78 are provided. However, it should be understood by those skilled in the art that more than two ventilation channels 78 or less than two ventilation channels 78 may be employed, consistent with the spirit and scope of the present invention. The ventilation channels 78 may help to reduce a feeding baby's ingestion of excess air and, in turn, may help to prevent discomfort to a baby during and after bottle feeding due to a buildup of excess gas, and also may help to prevent colic. The generally rounded shape of the base portion 74 is designed to simulate a natural breast, thereby helping to provide the best comfort to a child when feeding. The base portion 74 may include branding and/or a flow number thereon, which may be placed onto an exterior of the base portion 74 with a sandblasting treatment, creating a raised effect. Branding and/or a flow number may also be placed onto the base portion 74 in some other manner, as desired. The base portion 74 may further include a plurality of ribs 84 positioned on an interior surface of the base portion 74, encircling the tip 76. The tip 76 of the nipple 70 may be slightly angled. The tip 76 includes an opening to permit fluid flow to a child's mouth during feeding. In one embodiment, the nipple 70 may be transparent and may be comprised of a clear finish.

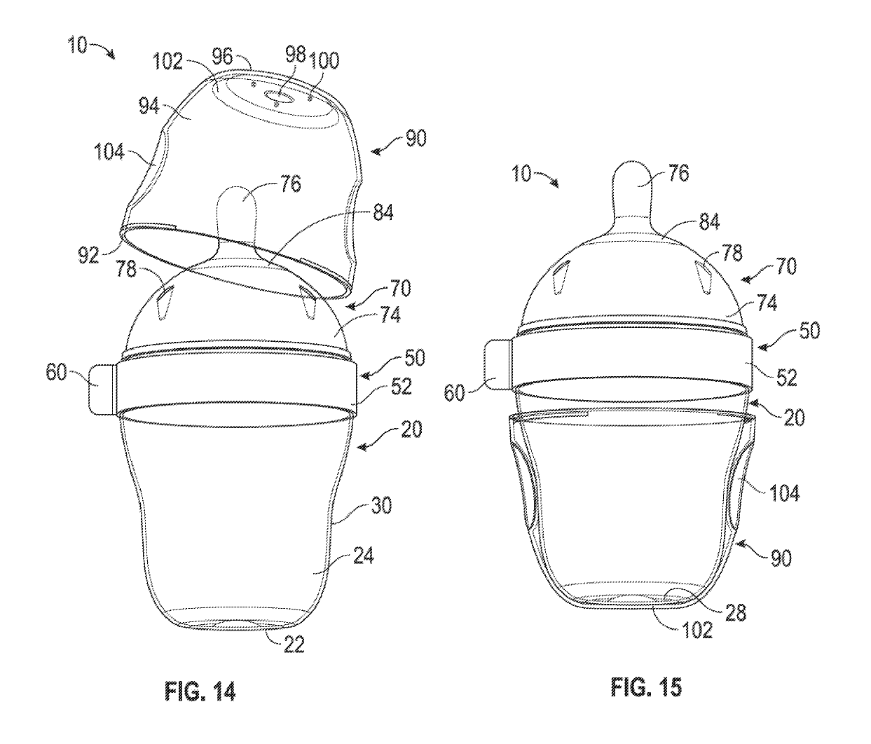

Referring now to FIGS. 1-3, 9 and 14, particular attention is drawn to the cap 90. The cap 90 comprises a generally inverted cup-shape, with an open bottom 92, a side wall 94 defining a perimeter of the cap 90, and a closed top 96. An interior region of the top 96 of the cap 90 includes a capsule 98, which is adapted to receive the tip 76 of the nipple 70 when the cap 90 is in position on the fully assembled baby bottle assembly 10. In this way, the cap 90 helps to hold the tip 76 of the nipple 70 in place and to prevent liquid from leaking out of the tip 76. The top 96 of the cap 90 may further include a plurality of ventilation holes 100, as shown in FIG. 1. In one embodiment, three ventilation holes 100 are provided. However, it should be understood by those skilled in the art that more than three ventilation holes 100 or less than three ventilation holes 100 may be provided, consistent with the spirit and scope of the present invention. The cap 90 may further include a nesting region 102 positioned proximate the top 96 of the cap 90. When the cap 90 is removed from the baby bottle assembly 10 and inverted, the bottle base 20 may then be nested within the cap 90 and snapped into place. The side wall 94 of the cap 90 may be generally rounded in shape and may include a recessed thumb region 104. In this way, a user may place his or her thumb into the recessed thumb region 104, enabling the user to grip and easily remove the cap 90. In this embodiment, the cap 90 is tapered, with a circumference of the bottom 92 being greater than a circumference of the top 96 of the cap 90. This tapering feature permits a plurality of caps 90 to be stacked for storage, as further described herein. In one embodiment, the cap 90 may be transparent and may be comprised of a clear finish.

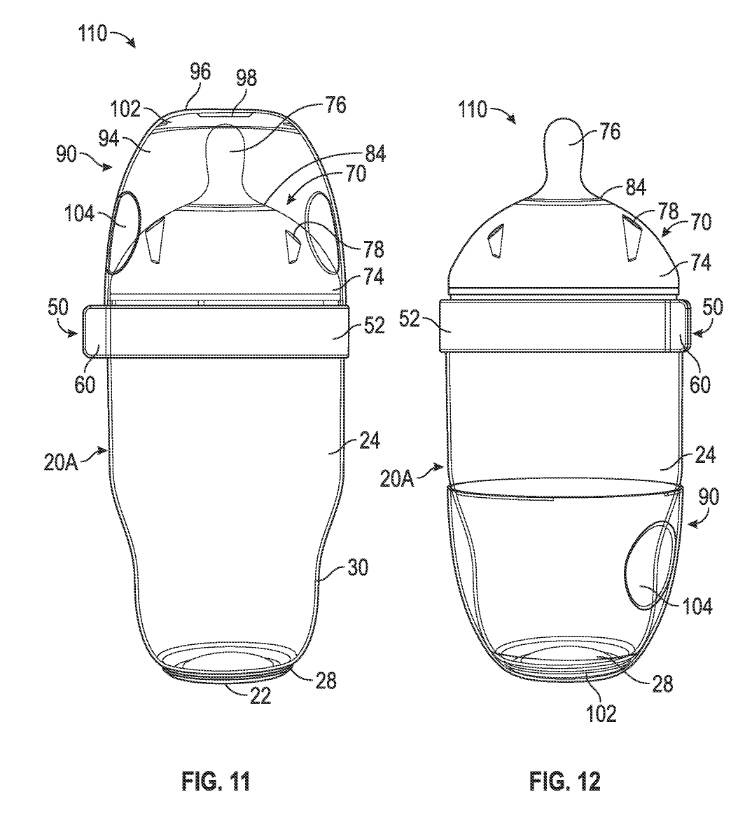

Turning now to FIGS. 11-12, another embodiment of the stackable baby bottle assembly 10, hereinafter 110, consistent with an embodiment of the present invention is shown. The baby bottle assembly 110 is similar to the baby bottle assembly 10, except that it includes a taller bottle base 20, hereinafter 20A, which is dimensioned to receive a greater amount of liquid than the bottle base 20 of the baby bottle assembly 10. An embodiment of bottle base 20A may also be seen in FIG. 7. Overall, the baby bottle assembly 110 provides the same features and benefits as the baby bottle assembly 10. Like the baby bottle assembly 10, the baby bottle assembly 110 may be comprised of the following principal components: a bottle base 20A, a sieve 40 (as may be seen in FIGS. 1 and 5), a ring 50, a nipple 70, and a cap 90. It should be noted that the sieve 40, ring 50, nipple 70, and cap 90 are interchangeable in that each may be employed with either the bottle base 20 or bottle base 20A. The side wall 24 of the bottle base 20A may include gradation markings on an exterior thereof. The gradation markings may include liquid measurement markings in English or metric units, such as ounces or milliliters. In one embodiment, the gradation markings may include liquid measurement markings up to 9 ounces and up to 250 milliliters. However, it should be understood by those skilled in the art that liquid measurement markings outside of these ranges may be provided, consistent with the spirit and scope of the present invention. The bottle base 20A may be dimensioned to contain approximately 9 ounces or 250 milliliters of fluid. In this embodiment, the baby bottle assembly 110 may have a total height of 177.3 millimeters and a diameter at its widest part of 77.6 millimeters. However, the bottle base 20A may be dimensioned to contain more or less fluid outside of these dimensions, and the baby bottle assembly 110 may have varying heights and diameters, as desired, consistent with the spirit and scope of the invention.

In order to assemble the baby bottle assembly 10 or 110 for use a user would place a desired amount of formula, milk, or other liquid to be fed to a child within the bottle base 20 or 20A. A user would then place the sieve 40 on top of the bottle base 20 or 20A. A user would next place the nipple 70 on top of the sieve 40. (Alternatively, if a user wishes not to use the sieve 40, the user would omit the step of placing the sieve 40 onto the bottle base 20 or 20A and would instead place the nipple 70 directly onto the bottle base 20 or 20 A.) After placing the nipple 70, a user would then secure the nipple 70 and sieve 40 in place onto the bottle base 20 or 20A by screwing the ring 50 onto the bottle base 20 or 20A. When the ring 50 is screwed onto the bottle base 20 or 20A, the lip 56 of the ring catches lower edge 72 of the nipple 70, holding the nipple 70 in place. (In the event that a user does not use the sieve 40, the user would secure only the nipple 70 in place onto the bottle base 20 or 20A by screwing the ring 50 onto the bottle base 20 or 20A.) Finally, a user would snap the cap 90 into place on the ring 50, with the tip 76 of the nipple 70 being held in place within the capsule 98 of the cap 90. The cap 90 could remain in place until a user is ready to feed a child with the baby bottle assembly 10 or 110. When ready to feed a child, a user would remove the cap 90 and proceed to feed the child.

When it comes time for feeding a child using the baby bottle assembly 10 or 110, a user may wish to take advantage of the nestable cap feature, as may be seen in FIGS. 10, 12, and 15. A user may remove the cap 90 from the top of the baby bottle assembly 10 or 110. A user may then invert the cap 90 and place the bottle base 20 or 20A into the cap 90. The user would then snap the cap 90 into place on the bottle base 20 or 20A, with nesting region 28 of the bottle base 20 or 20A coupling to nesting region 102 of the cap 90. With the nestable cap feature, a user may conveniently and securely store the cap 90 during feeding.

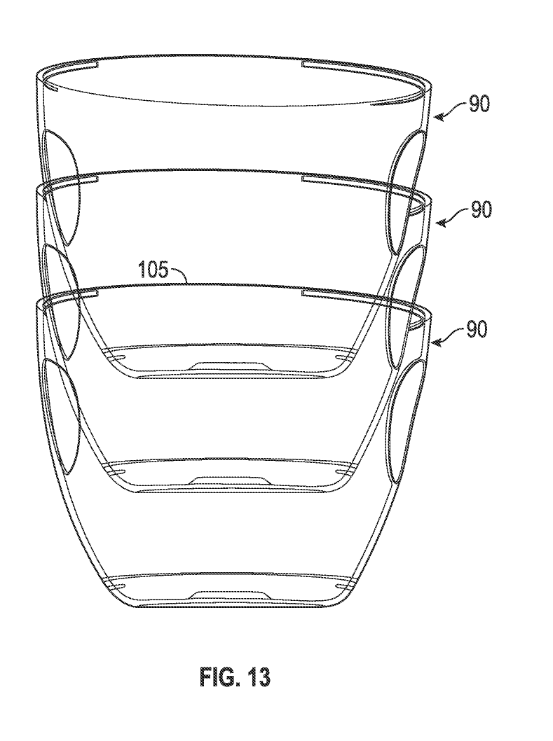

When the baby bottle assembly 10 or 110 is not in use, a user may wish to organize and store components of a plurality of baby bottle assemblies 10 or 110, such as a plurality of caps 90. A plurality of caps 90 may be stored in a stacked arrangement by placing a first cap 90 into a second cap 90 and a third cap 90 into a second cap 90, and so on. This stacking feature is shown in FIG. 13. Although in this embodiment three caps 90 are shown in a stacked arrangement, more than three caps 90 or less than three caps 90 may be stacked, as desired. The stacking feature permits a user to neatly organize and store a plurality of caps 90 vertically, thereby taking up less space on a countertop or in a cupboard or drawer, for example, or in some other desired location, than if the caps 90 were stored side by side. It should be noted that the ventilation holes 100 in the caps may allow air to flow through the plurality of caps 90 when the plurality of caps 90 may be stored in a stacked arrangement. Further, since the recessed thumb region 104 may be formed on opposing sides of the caps 90, the recessed thumb region 104 may cause channels 105 to form between successive caps 90 in the stacked arrangement. The channels may allow air to flow through the plurality of caps 90 when the plurality of caps 90 may be stored in a stacked arrangement.

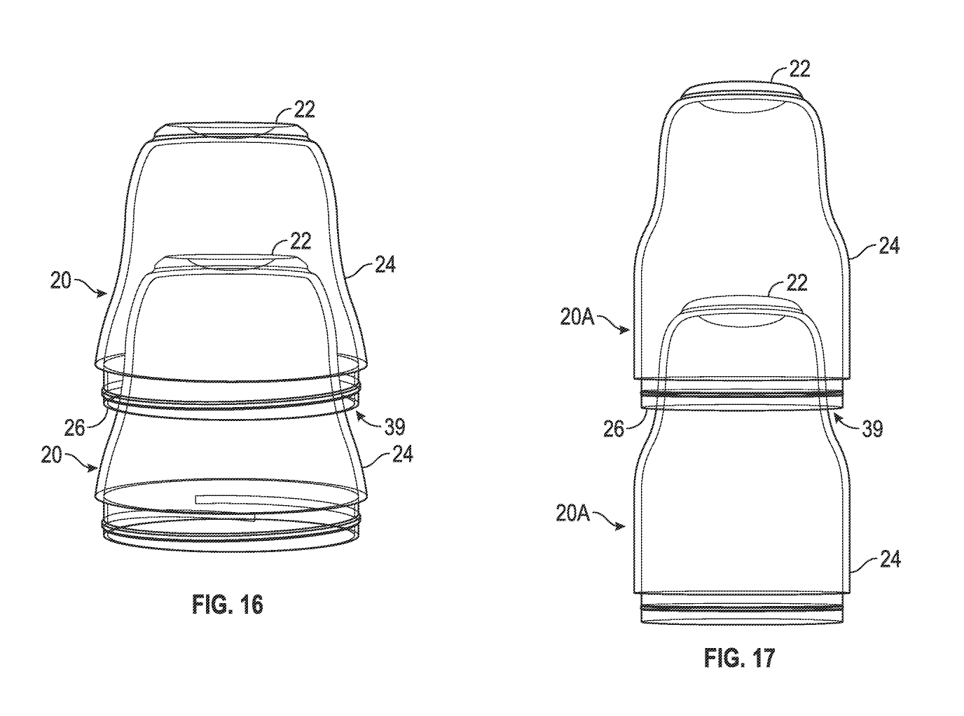

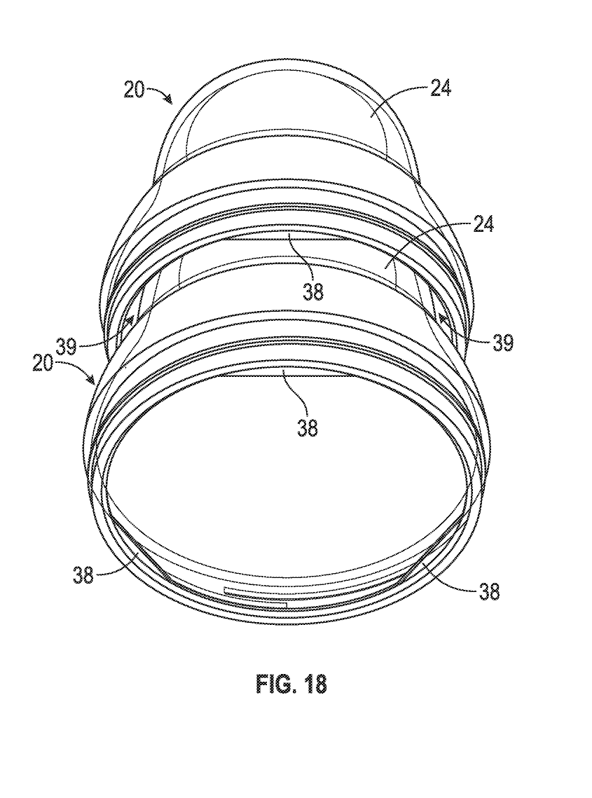

When the baby bottle assembly 10 or 110 is not in use, a user may wish to organize and store components of a plurality of baby bottle assemblies 10 or 110, such as a plurality of bottle bases 20 or 20A. A plurality of bottle bases 20 or 20A may be stored in a stacked arrangement by placing a first bottle base 20 or 20A onto a second bottle base 20 or 20A, and so on. In order to stack a plurality of bottle bases 20 or 20A, an open top 26 of a second bottle base 20 or 20A would be placed over a closed bottom 22 of a first bottle base 20 or 20A, an open top of a third bottle base 20 or 20A would be placed over a closed bottom 22 of the second bottle base 20 or 20A, and so on. This stacking feature is shown in FIGS. 16 and 18 with respect to bottle base 20, and in FIG. 17 with respect to bottle base 20A, Although in these embodiments two bottle bases 20 or 20A are shown in a stacked arrangement, more than two bottle bases 20 or 20A may be stacked, as desired. The stacking feature permits a user to neatly organize and store a plurality of bottle bases 20 or 20A vertically, thereby taking up less space on a countertop or in a cupboard or drawer, for example, or in some other desired location, than if the bottle bases 20 or 20A were stored side by side. While in a stacked arrangement, the edge members 38 of the second bottle bases 20 or 20A that are placed onto first bottle bases 20 or 20A contact an exterior portion of the side wall 24 of the first bottle bases 20 or 20A, forming a plurality of spaces 39 between the second bottle bases 20 or 20A and the first bottle bases 20 or 20A, permitting air to flow between the bottle bases 20 or 20A when stacked, as may be seen in particular in FIG. 18. If a user desires to stack additional bottle bases 20 or 20A, the edge members 38 of additional bottle bases 20 or 20A would form a plurality of spaces 39 between consecutive bottle bases 20 or 20A, in the same manner, permitting air to flow between the bottle bases 20 or 20A.

While embodiments of the disclosure have been described in terms of various specific embodiments, it will be recognized and understood by those skilled in the art that the embodiments of the disclosure may be practiced with modifications without departing from the spirit and scope of the invention.

What is claimed is:

1. A baby bottle assembly comprising, in combination:
a bottle base having a plurality of edge members formed in an interior perimeter of the bottle base, the edge members forming spaces when a plurality of bottle bases are stacked together;
a ring coupled to the bottle base;
a nipple adapted to be placed onto the bottle base;
a cap adapted to be snapped into place onto the ring.

2. The baby bottle assembly of claim 1, further comprising a sieve positioned between the bottle base and the ring.

3. The baby bottle assembly of claim 1, wherein the bottle base further comprises a nesting region positioned proximate the bottom of the bottle base.

4. The baby bottle assembly of claim 3, wherein the cap further comprises a nesting region positioned proximate the top of the cap.

5. The baby bottle assembly of claim 1, wherein the nipple further comprises a plurality of ventilation channels positioned in a base portion of the nipple.

6. The baby bottle assembly of claim 1, wherein the cap further comprises a plurality of ventilation holes.

7. A baby bottle assembly comprising, in combination:
a bottle base having a closed bottom, a side wall, an open top, a plurality of edge members formed in an interior perimeter of the bottle base, and an external threaded region positioned proximate the top of the bottle base;
a ring having an outer wall, a threaded inner wall, a lip, and a shoulder;
a nipple having a lower edge, a generally rounded base portion, and a tip;
a cap having an open bottom, a side wall, a closed top, and a capsule positioned in an interior region of the closed top;
wherein the nipple is adapted to be placed onto the bottle base;
wherein the threaded inner wall of the ring is adapted to be threadably coupled to the external threaded region of the bottle base and wherein the lip of the ring is adapted to secure the lower edge of the nipple onto the bottle base when the ring is coupled to the bottle base;
wherein the cap is adapted to be snapped into place onto the shoulder of the ring; and
wherein the cap is adapted to receive the tip of the nipple when the cap is in place on the shoulder of the ring.

8. The baby bottle assembly of claim 7, further comprising a sieve adapted to be removably positioned between the bottle base and the ring, wherein the sieve comprises a circular-shaped disk having a plurality of openings.

9. The baby bottle assembly of claim 7, wherein the ring further comprises a tab positioned on an outer surface of the ring.

10. The baby bottle assembly of claim 7, wherein an outer surface of the ring is dimpled.

11. The baby bottle assembly of claim 7, wherein the bottle base includes three edge members.

12. The baby bottle assembly of claim 7, wherein the bottom of the bottle base is dome shaped.

13. The baby bottle assembly of claim 7, wherein the bottle base further comprises a nesting region positioned proximate the bottom of the bottle base.

14. The baby bottle assembly of claim 13, wherein the cap further comprises a nesting region positioned proximate the top of the cap.

15. The baby bottle assembly of claim 7, wherein the nipple further comprises a plurality of ventilation channels positioned in the base portion of the nipple.

16. The baby bottle assembly of claim 7, wherein the cap further comprises a plurality of ventilation holes.

17. A baby bottle assembly comprising, in combination:
a bottle base having a closed bottom, a side wall, an open top, a plurality of edge members formed in an interior perimeter of the bottle base, and an external threaded region positioned proximate the top of the bottle base;
a sieve comprising a circular-shaped disk having a plurality of openings;
a ring having an outer wall, a threaded inner wall, a lip, and a shoulder;
a nipple having a lower edge, a generally rounded base portion, and a tip;
a cap comprising an open bottom, a side wall, a closed top, and a capsule positioned in an interior region of the top;
wherein the sieve is adapted to be removably positioned between the bottle base and the ring;
wherein the nipple is adapted to be placed onto the sieve;
wherein the threaded inner wall of the ring is adapted to be threadably coupled to the external threaded region of the bottle base and wherein the lip of the ring is adapted to secure the lower edge of the nipple onto the sieve when the ring is coupled to the bottle base;
wherein the cap is adapted to be snapped into place onto the shoulder of the ring; and
wherein the cap is adapted to receive the tip of the nipple when the cap is in place on the shoulder of the ring.

18. The baby bottle assembly of claim 17, wherein the bottle base further comprises a nesting region positioned proximate the bottom of the bottle base.

19. The baby bottle assembly of claim 18, wherein the cap further comprises a nesting region positioned proximate the top of the cap.

20. The baby bottle assembly of claim 17, wherein the cap further comprises a plurality of ventilation holes.
